(19) United States
(12) Patent Application Publication
(10) Pub. No.: US 2024/0369815 A1
(43) Pub. Date: Nov. 7, 2024

(54) APPARATUS AND METHOD FOR COAXIAL LINE-SCANNING BRILLOUIN MICROSCOPY

(71) Applicant: WAYNE STATE UNIVERSITY, Detroit, MI (US)

(72) Inventor: Jitao ZHANG, Troy, MI (US)

(73) Assignee: WAYNE STATE UNIVERSITY, Detroit, MI (US)

(21) Appl. No.: 18/779,030

(22) Filed: Jul. 21, 2024

Related U.S. Application Data
(63) Continuation-in-part of application No. PCT/US2023/011271, filed on Jan. 20, 2023.
(60) Provisional application No. 63/301,166, filed on Jan. 20, 2022.

(51) Int. Cl. G02B 21/00; G01N 21/63; G02B 21/08

(52) U.S. Cl. CPC G02B 21/002; G01N 21/636; G02B 21/082; G01N 2021/638

(57) ABSTRACT

A line-scan Brillouin microscopy apparatus is configured to operate in a coaxial configuration. The line-scan Brillouin microscopy apparatus includes an illumination source that provides a P polarized illumination light beam for illuminating a sample. A first optical assembly provides the P polarized illumination light beam to the sample and collects initial Brillouin scattered light from the sample. The first optical assembly includes an optical component that converts the initial Brillouin scattered light to S polarized Brillouin scattered light. A second optical assembly is configured to receive the S polarized Brillouin scattered light from the first optical assembly. Characteristically, the second optical assembly is configured to induce a spectral dispersion. A detection unit is configured to detect a spatio-spectral pattern of the initial Brillouin scattered light. Advantageously, multiple points of the sample along P polarized illumination light beam are measured simultaneously.

### CROSS-REFERENCE TO RELATED APPLICATIONS

This application is a continuation-in-part of PCT Appln. No. PCT/US2023/011271 filed Jan. 20, 2023, which claims the benefit of U.S. provisional application Ser. No. 63/301,166 filed Jan. 20, 2022, the disclosures of which are hereby incorporated in their entirety by reference herein.

### TECHNICAL FIELD

The present disclosure relates to the improvements to Brillouin microscopy techniques. Specifically, the present disclosure relates to the development of the apparatus and method of coaxial line-scanning Brillouin microscopy. The invented apparatus and method can rapidly obtain the mechanical properties of the sample with reduced system complexity. Importantly, because of the coaxial configuration developed in this disclosure, the invented apparatus and method are tolerant to the artifact induced by the inhomogeneity and opaqueness of the sample.

### BACKGROUND

Brillouin microscopy is an emerging optical technology for quantifying the mechanical properties (e.g., longitudinal modulus and viscosity) of the material in a non-contact, non-perturbative, and label-free manner [1]. The physical basis of the Brillouin technique is Brillouin light scattering, which is the phenomenon of inelastic light scattering induced by inherent acoustic phonons of a material [2]. As a laser beam illuminates on a sample, because of Brillouin scattering, a portion of the beam will be scattered and experience a small frequency shift (typically in the order of GHz, corresponding to <0.01 nm in wavelength), which is usually called Brillouin shift. Since the Brillouin shift is the result of the interaction between incident photon and the acoustic phonon of the material, the quantification of Brillouin shift can be used to assess the mechanical properties of the material. To resolve such a small frequency shift, common optical filters cannot be used. Instead, a specific spectrometer with ultrahigh spectral resolution is required.

To date, two types of Brillouin spectrometers have been developed and widely adopted in practice. The first-type Brillouin spectrometer is based on a scanning Fabry-Perot (FP) etalon [3], which resolves the different frequency components by scanning the physical distance of the etalon. While FP etalon can provide high spectral resolution and extinction, its throughput is intrinsically low because it forms an interference pattern in both transmission and reflection. In addition, its acquisition time is extremely long due to the physical scanning of each spectral component in sequence. As such, FP etalon-based Brillouin spectrometer needs minutes or even hours to acquire a full Brillouin spectrum. Recently, this speed constraint was significantly mitigated by the second-type spectrometer, which is based on a virtually imaged phased array (VIPA) etalon [4]. VIPA etalon can create large angular dispersion, thus allowing to acquire the full Brillouin spectrum with one-shot. Therefore, this non-scanning configuration is ˜100 times faster than FP etalon. By integrated VIPA-based Brillouin spectrometer with a standard microscope, confocal Brillouin microscope was first reported in 2008, making it possible to measure biological samples in physiological and pathological conditions [5]. Very recently, the mechanical image of a single cell at sub-micron resolution has been obtained by Brillouin microscopy [6]. Following these technical advancements, the adoption of the Brillouin technique has expanded into many biomedical fields, including ocular biomechanics [7-13], developmental biomechanics [14-18], cellular biomechanics [6, 19-24], cancer metastasis and 3D tumorigenesis [25-27], biomaterial characterization [28-34], and medical applications [35-40]. Despite of current accomplishments, the confocal Brillouin microscope is still much slower than other existing imaging modalities, such as a fluorescent microscope. This makes it highly challenging for large samples (such as embryo, spheroid, and organoid) imaging as well as 3D mapping.

The slow speed (typically 100 ms per point) of the confocal Brillouin microscope is inherently limited by the extremely low efficiency of the spontaneous Brillouin scattering process. One approach to break this limit is to utilize the stimulated Brillouin scattering (SBS), which is a nonlinear process and can generate much stronger Brillouin signal. Very recently, the SBS microscopy

has been successfully demonstrated by using two tunable continuous-wave lasers [41]. However, since the excitation of the stimulated process requires the presence of intense laser light, the potential phototoxicity to various biological samples during volumetric imaging needs further investigation. On the other hand, the low efficiency of spontaneous Brillouin scattering itself implies a possible opportunity: since the majority of the illumination light is not scattered but transmitted, the reuse of the transmitted portion of the light could generate extra Brillouin signal, thus improving the overall efficiency. To this end, we have proposed a line-scanning configuration in which the illumination axis and the detection axis are orthogonal (biaxial configuration) so that multiple points along the

illumination axis can be measured simultaneously [42]. Compared with confocal Brillouin microscopy, line-scanning Brillouin microscopy (LSBM) can improve the imaging speed by about 100 folds, pushing the acquisition time to be less than 1 ms per point. However, the biaxial configuration of the LSBM setup has several limitations. First, since the illumination path and detection path are spatially independent, it makes the initial alignment of two-beam paths very difficult and increases the complexity of sample preparation and loading. For example, to maintain the overlap of the beam paths and make the biological sample optically accessible, the sample needs to be transferred from its culturing condition into a solid hydrogel and then placed into a cuvette filled with medium. This process also brings about the concern that the sample may change its behavior and mechanical properties during the preparation process. Second, for biological samples with inhomogeneous refractive index, the optical distortion will cause the deviation of the collected scattering angles from the preset value (i.e., 90°), thus introducing artifact to the experiment. Third, for non-transparent biological samples, limited by the penetration depth of the illumination beam, the designed field-of-view usually cannot be fully used, which undermines the multiplexing power of LSBM.

In brief, Brillouin technology has emerged as a unique complementary tool to traditional methods (such as atomic force microscopy, compression test machine, rheometer, and

micropipette aspiration) as it allows non-contact, non-perturbative, label-free measurement [43]. Although Brillouin microscopy is rapidly recognized for quantifying live biological samples, the technology itself is still in the infancy stage and has the aforementioned limitations.

Accordingly, there exists a general need for developing new apparatus and method of Brillouin microscopy that can reduce the system complexity and enhance the tolerance to the inhomogeneous and/or non-transparent samples.

### SUMMARY

In at least one aspect, an apparatus and method of coaxial LSBM that overcomes the limitations of the prior art are provided. Compared with existing LSBM based on separated illumination and detection paths (i.e., biaxial configuration), the coaxial configuration developed in this disclosure allows the illumination and detection to share the same optical path, thus making the setup less complicated, easier for optical alignment and sample preparation, and more tolerant to inhomogeneous and non-transparent biological samples. Specifically, the coaxial LSBM uses the same objective lens to create an illumination line and then collect the corresponding Brillouin signals for spectral analysis. A 2D or 3D mechanical image can be acquired by scanning either the beam line or the sample, which retains the advantage of multiplexing, thus allowing rapid measurement. Benefiting from such configuration, the preparation and loading of the sample is significantly simplified: the sample can be seeded onto the standard petri dish and measured under its culturing condition. This will remove any concern about the alteration of the sample's property during an experiment. In addition, the coaxial design ensures that the collected scattering angle (i.e., 180°) at different positions keeps unchanged for inhomogeneous samples, which removes the artifact often encountered in the existing LSBM. Finally, since the illumination and detection are on the same side of the sample, the field-of-view will not be affected by the penetration depth of the illumination beam. Beyond that, the coaxial configuration allows the adoption of the existing technique for compensating beam distortion in opaque material, thus having the potential to extend the measurement depth.

In another aspect, a line-scan Brillouin microscopy apparatus is configured to operate in a coaxial configuration. The line-scan Brillouin microscopy apparatus includes an illumination source that provides a P polarized (i.e., a linearly polarized light whose electrical filed is parallel to the plane of incidence) illumination light beam for illuminating a sample. A first optical assembly provides the P polarized illumination light beam to the sample and collects initial Brillouin scattered light from the sample. The first optical assembly includes an optical component that converts the initial Brillouin scattered light to S polarized (i.e., a linearly polarized light whose electrical filed is perpendicular to the plane of incidence) Brillouin scattered light. A second optical assembly is configured to receive the S polarized Brillouin scattered light from the first optical assembly. Characteristically, the second optical assembly is configured to induce a spectral dispersion. A detection unit is configured to detect a spatio-spectral pattern of the initial Brillouin scattered light. Advantageously, multiple points of the sample along P polarized illumination light beam are measured simultaneously.

In another aspect, a line-scan Brillouin microscopy apparatus is configured to operate in a coaxial configuration. The line-scan Brillouin microscopy apparatus includes an illumination source that provides a P polarized illumination light beam for illuminating a sample. A first optical assembly provides the P polarized illumination light beam to the sample and collects initial Brillouin scattered light from the sample. The first optical assembly includes an optical component that converts the initial Brillouin scattered light to S polarized Brillouin scattered light. The first optical assembly includes a polarized beam splitter, a quarter-wave plate, and an objective lens. The polarized beam splitter is configured to reflect at least a portion of the P polarized illumination light beam towards the sample. The quarter-wave plate and the objective lens are configured to focus the P polarized illumination light beam onto the sample. The objective lens is also configured to collect the initial Brillouin scattered light and direct the initial Brillouin scattered light to the quarter-wave plate, which converts the initial Brillouin scattered light to the S polarized Brillouin scattered light. A second optical assembly is configured to receive the S polarized Brillouin scattered light from the first optical assembly. Characteristically, the second optical assembly is configured to induce a spectral dispersion. A detection unit is configured to detect a spatio-spectral pattern of the initial Brillouin scattered light. Advantageously, multiple points of the sample along the P polarized illumination light beam are measured simultaneously.

In another aspect, a line-scanning Brillouin technique that has a simplified process for setup alignment, sample preparation, and sample loading is provided.

In another aspect, a line-scanning Brillouin technique that is tolerant to inhomogeneous and non-transparent biological samples is provided.

In another aspect, a line-scanning Brillouin technique for improved speed is provided.

In another aspect, the line scan Brillouin microscope and related method provide full use of the field of view.

In another aspect, the line scan Brillouin microscope and related method are more tolerant to optical aberrations.

Advantageously, the line scan Brillouin microscope and related method operating in a coaxial configuration improve image quality, which is especially valuable in biological images.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1 provides a general schematic of apparatus for coaxial line-scanning Brillouin microscopy.

FIG. 2 illustrates the first exemplary embodiment of this invention. It shows the schematic configuration of the coaxial line-scanning Brillouin microscopy.

FIG. 3 illustrates the second exemplary embodiment of this invention. It shows the schematic configuration of the coaxial line-scanning Brillouin microscopy.

FIGS. 4A and 4B explain the general advantage of line-scanning configuration comparing with confocal configuration in Brillouin microscopy.

FIG. 5 illustrates a proof-of-concept experiment that demonstrates the typical Brillouin spectrum acquired by the line-scanning Brillouin microscopy.

FIGS. 6A and 6B illustrate the advantage of coaxial configuration comparing with biaxial configuration for non-transparent biological sample. The inset indicates the optical configuration.

FIGS. 7A and 7B illustrate the advantage of coaxial configuration comparing with biaxial configuration for inhomogeneous sample. n₁ and n₂ are refractive index of the sample and the ambient environment, respectively (assuming n₁>n₂).

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

With respect to electrical devices, the term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The term “electrical communication” means that an electrical signal is either directly or indirectly sent from an originating electronic device to a receiving electrical device. Indirect electrical communication can involve processing of the electrical signal, including but not limited to, filtering of the signal, amplification of the signal, rectification of the signal, modulation of the signal, attenuation of the signal, adding of the signal with another signal, subtracting the signal from another signal, subtracting another signal from the signal, and the like. Electrical communication can be accomplished with wired components, wirelessly connected components, or a combination thereof.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

The term “electrical signal” refers to the electrical output from an electronic device or the electrical input to an electronic device. The electrical signal is characterized by voltage and/or current. The electrical signal can be stationary with respect to time (e.g., a DC signal) or it can vary with respect to time. The term “computing device” refers generally to any device that can perform at least one function, including communicating with another computing device. In a refinement, a computing device includes a central processing unit that can execute program steps and memory for storing data and a program code.

When a computing device is described as performing an action or method step, it is understood that the one or more computing devices are operable to perform the action or method step typically by executing one or more lines of source code. The actions or method steps can be encoded onto non-transitory memory (e.g., hard drives, optical drive, flash drives, and the like).

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

Throughout this application, where publications are referenced, the disclosures of these publications in their entireties are hereby incorporated by reference into this application to more fully describe the state of the art to which this invention pertains.

### ABBREVIATIONS

“PBS” means polarized beam splitter.

“FP” means Fabry Perot.

“VIPA” means virtually-imaged phased array.

In at least one aspect, an apparatus and method for coaxial line-scanning Brillouin microscopy is provided. The apparatus and method advantageously apply Brillouin scattering which operates as follows. As a laser beam is shined on the sample, the spontaneous Brillouin scattering process will introduce the Brillouin frequency shift f_{B} to the scattered light:

$${f}_{B} = \frac{2 n}{λ} \cdot \sqrt{\frac{M}{ρ}} \cdot sin ( θ / 2 ) , \qquad ( 1 )$$

where λ is the wavelength of the laser light, M is the longitudinal modulus that represents the mechanical property of the material, n and ρ is the refractive index and density of the material, respectively, and θ is the scattering angle (in this disclosure, θ=180°). Equation (1) reveals the physical basis of the Brillouin technique: by measuring the Brillouin shift f_{B} with a specific spectrometer, one can access the longitudinal modulus M of the material with known of the rest parameters.

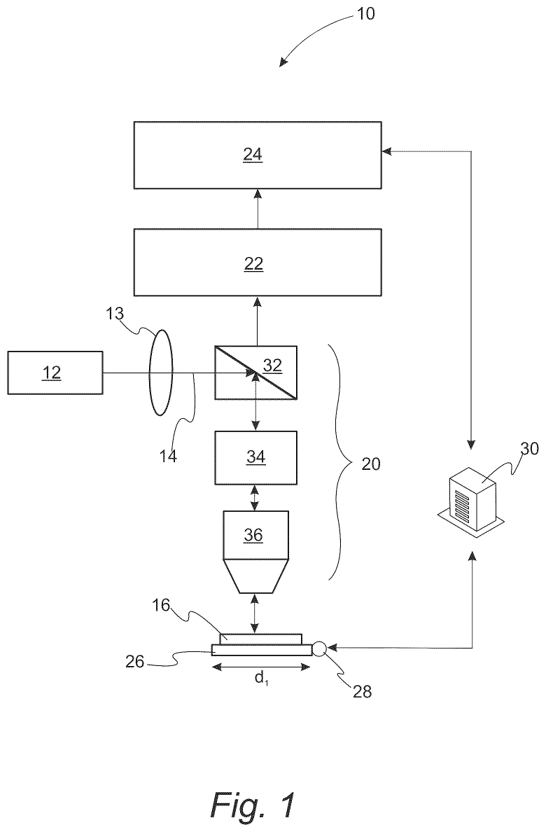

With reference to FIG. 1, a line-scan Brillouin microscopy apparatus configured to operate in a coaxial configuration. Line-scan Brillouin microscopy apparatus 10 includes an illumination source 12 that provides a P polarized illumination light beam 14 for illuminating a sample 16. In a refinement, the light beam passes through cylindrical lens 13 for reshaping the laser beam from 12. Therefore, the illumination beam on the sample 16 becomes a line. Typically, illumination source 12 includes a laser that provides light having a wavelength from about 350 nm to 1000 nm (e.g., a 780-nm tunable laser). First, optical assembly 20 provides the P polarized illumination light beam to the sample and collects initial Brillouin scattered light from sample 16. The first optical assembly 20 includes an optical component that converts the initial Brillouin scattered light to S polarized Brillouin scattered light. Second optical assembly 22 is configured to receive the S polarized Brillouin scattered light from the first optical assembly 20. Characteristically, the second optical assembly 22 is configured to induce a spectral dispersion. Detection unit 24 detects a spatio-spectral pattern of the S polarized Brillouin scattered and therefore of the initial Brillouin scattered light. Typically, detection unit 24 includes an image sensor having a pixel array of photodetectors. Therefore, detection unit 24 can be a digital camera. Advantageously, multiple points of the sample along P polarized illumination light beam are measured simultaneously.

In a refinement, line-scan Brillouin microscopy apparatus 10 further includes a translatable sample holder 26 having motor 28 that is configured to move the sample 16 along a predetermined direction d₁. This translation allows at least a section of the sample to be scanned so that 2D and 3D images can be constructed.

Advantageously, the detected spatio-spectral pattern of the S polarized obtained from detection unit 24 can be used to calculate one or more Brillouin metrics. Examples of such metrics include Brillouin frequency shift, Brillouin spectrum line width, Brillouin gain or loss spectrum, and a combination thereof. Moreover, the one or more Brillouin metrics determine a mechanical property of the sample. Examples of mechanic properties include elasticity, viscosity, stiffness, and combinations thereof.

In some particularly useful applications, sample 12 is a biological sample. Examples of biological samples include a biological organism and/or a tissue and/or biological cells including living cells.

In a variation as depicted in FIG. 1, first optical assembly 20 can include a beam splitter 32 configured to reflect at least a portion of the P polarized illumination light beam towards the sample 16. In this embodiment, beam splitter 32 is a polarized beam splitter so it will be referred to as polarized beam splitter 32. The first optical assembly 10 can further include a quarter-wave plate 34 and an objective lens 36, the quarter-wave plate and the objective lens being configured to focus the P polarized illumination light beam onto the sample, the objective lens being also configured to collect the initial Brillouin scattered light and direct the initial Brillouin scattered light to the quarter-wave plate which converts the initial Brillouin scattered light to the S polarized Brillouin scattered light thereby allowing the polarized beam splitter to pass the S polarized Brillouin scattered light to the second optical assembly.

As set forth above, line-scan Brillouin microscopy apparatus 10 includes second optical assembly 22 configured to induce a spectral dispersion. As is known it the art, optical assembly 22 can include a virtually imaged phased array (VIPA), a Fabry-Perot etalon, or an optical grating. In a refinement, second optical assembly 22 further comprises optical elements to modify size, shape, and/or angular spread of the spatio-spectral pattern in an optical path from the sample to the detection unit. Examples of second optical assembly 22 configured to induce a spectral dispersion are provided in U.S. Pat. Nos. 10,386,288; 10,598,594; and 10,732,092; the entire disclosures of which are hereby incorporated by reference.

In a variation, line-scan Brillouin microscopy apparatus 10 further includes a computing device 30 configured to execute instructions for determining a detected spatio-spectral pattern. In this regard, computing device 30 is in electrical communication with detector unit 24. In a refinement, computing device 30 is in electrical communication with detector unit 24 the motor 28 of translatable sample holder 28 so as to synchronize collection of the Brillouin scattered light from each line along the sample. In a refinement, computing device 30 is further configured to execute instructions for calibrating the spatio-spectral pattern at each spatial point at the detection unit and calculating one or more Brillouin metrics at each measured sample point based on the detected spatio-spectral pattern.

In another embodiment, a method for detecting one or more mechanical properties of a plurality of cells in the sample with the line-scan Brillouin microscopy apparatuses set forth herein is provided. The method includes steps of illuminating a sample with the P polarized illumination light beam and simultaneously measuring Brillouin scattered light from multiple points of the sample along the P polarized illumination light beam.

In another embodiment, a line-scan Brillouin microscopy apparatus configured to operate in a coaxial configuration using unpolarized light. With reference to FIG. 1, Line-scan Brillouin microscopy apparatus 10 includes an illumination source 12 that provides an unpolarized illumination light beam 14 for illuminating a sample 16. Typically, illumination source 12 includes a laser that provides light having a wavelength from about 350 nm to 1000 nm (e.g., a 780-nm tunable laser). First optical assembly 20 provides the unpolarized illumination light beam to the sample and collects Brillouin scattered light from sample 16. Second optical assembly 22 is configured to receive the Brillouin scattered light from the first optical assembly 20. Characteristically, the second optical assembly 22 is configured to induce a spectral dispersion. Detection unit 24 detects a spatio-spectral pattern of the Brillouin scattered. Typically, detection unit 24 includes an image sensor having a pixel array of photodetectors. Therefore, detection unit 24 can be a digital camera. Advantageously, multiple points of the sample along unpolarized illumination light beam are measured simultaneously.

As set forth above, line-scan Brillouin microscopy apparatus 10 further includes a translatable sample holder 26 having motor 28 that is configured to move the sample 16 along a predetermined direction d₁. Advantageously, the detected spatio-spectral pattern of the unpolarized obtained from detection unit 24 can be used to calculate one or more Brillouin metrics as set forth above.

As set forth above, first optical assembly 20 can include a beam splitter 32 configured to reflect at least a portion of the unpolarized illumination light beam towards the sample 16. The first optical assembly 10 can further include an objective lens 36 which is configured to focus the unpolarized illumination light beam onto the sample. The objective lens is also configured to collect and direct the Brillouin scattered light to the beam splitter which passed the Brillouin scattered light to the second optical assembly. In this embodiment, beam splitter 32 need not be a polarized beam splitter and quarter-wave plate 34 need not be present.

As set forth above, line-scan Brillouin microscopy apparatus 10 includes second optical assembly 22 configured to induce a spectral dispersion.

In a variation, line-scan Brillouin microscopy apparatus 10 further includes a computing device 30 configured to execute instructions for determining a detected spatio-spectral pattern. In this regard, computing device 30 is in electrical communication with detector unit 24. In a refinement, computing device 30 is in electrical communication with detector unit 24 the motor 28 of translatable sample holder 28 so as to synchronize collection of the Brillouin scattered light from each line along the sample. In a refinement, computing device 30 is further configured to execute instructions for calibrating the spatio-spectral pattern at each spatial point at the detection unit and calculating one or more Brillouin metrics at each measured sample point based on the detected spatio-spectral pattern.

In another embodiment, a method for detecting one or more mechanical properties of a plurality of cells in the sample with the line-scan Brillouin microscopy apparatuses set forth herein is provided. The method includes steps of illuminating a sample with the unpolarized illumination light beam and simultaneously measuring Brillouin scattered light from multiple points of the sample along the unpolarized illumination light beam.

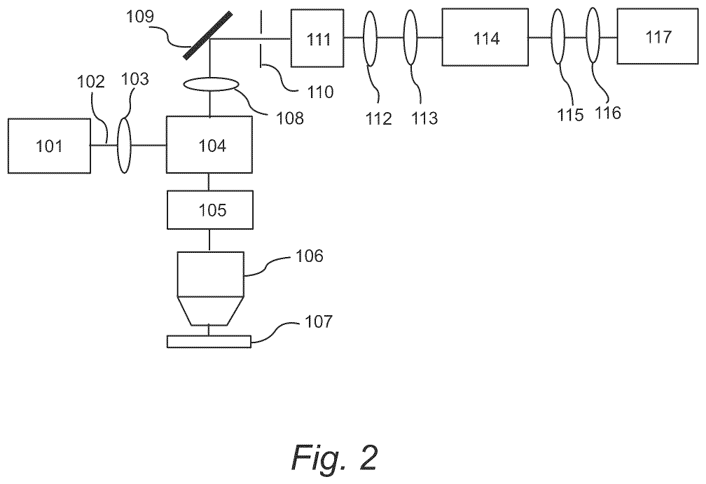

FIG. 2 shows the first exemplary embodiment of this invention. The light source 101 emits a collimated light beam 102 that is usually linearly polarized and has P polarization. After passing through the first cylindrical lens 103, the light beam 102 is first reflected by a polarized beam splitter 104 and then focused into a beam line inside the measured sample 107 by using the quarter-wave plate 105 and the objective lens 106. In a refinement, first cylindrical lens 103 reshapes the beam from 101. Therefore, the illumination beam on the sample 107 becomes a line. The fast axis of the quarter-wave plate 105 is set as 45° against the P polarization. The backward scattered light from the beam line is collected by the same objective lens 106. After passing through the quarter-wave plate 105, the scattered light becomes S polarized and thus transmitted by the polarized beam splitter 104. The light is then focused into a beam line on the mechanical slit 110 by using the first spherical lens 108 and the reflective mirror 109. The beam line then passes through a notch filter made with Rb gas cell 111 to reject any leaking light from the light source 101. After reshaped by the second spherical lens 112 and the second cylindrical lens 113, the beam line is coupled into the VIPA etalon 114 to spatially separate the Brillouin components from the non-Brillouin component, which is then projected onto the camera 117 by the third cylindrical lens 115 and fourth cylindrical lens 116. In this way, the mechanical properties of the illuminated region of the sample 107 is acquired by the camera 117 in a single shot.

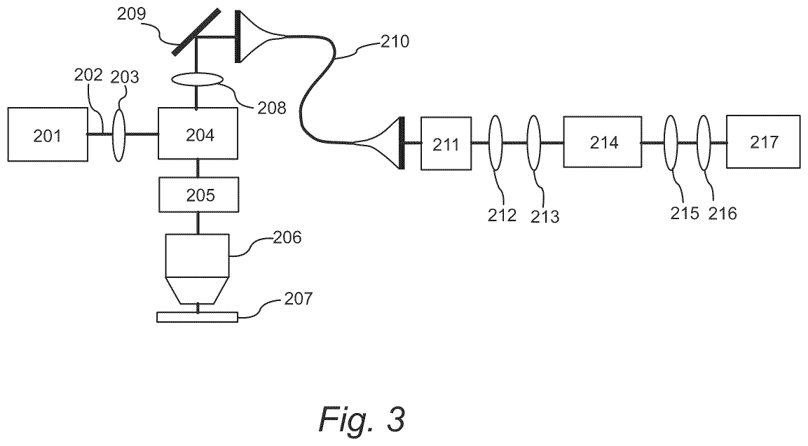

FIG. 3 shows the second exemplary embodiment of this invention. The function of the second exemplary embodiment is similar to the first exemplary embodiment, even though the assembly is different. Instead of using a mechanical slit, the second exemplary embodiment uses a one-dimensional (1D) fiber array to deliver the collected scattered light for spectral analysis. The adoption of a 1D fiber array not only provides a better optical sectioning ability but also allows more flexible design and implementation of the setup. For example, the system in FIG. 2 can now be divided into a measurement unit and a spectrum analysis unit, and the two units do not need to be housed onto the same optical table, which makes it possible for a remote or handheld experiment. The measurement unit is composed of the laser source 201, the first cylindrical lens 203, the polarized beam splitter 204, the quarter-wave plate 205, the objective lens 206, the first spherical lens 208, and the reflective mirror 209. The spectrum analysis unit is composed of the Rb gas cell 211, the second spherical lens 212, the second cylindrical lens 213, the VIPA etalon 214, the third and fourth cylindrical lens 215 and 216, and the camera 217. The collimated light beam 202 is emitted from the light source 201 and guided to sample 107 by the first cylindrical lens 203, the polarized beam splitter 204, the quarter-wave plate 205, and the objective lens 206. In a refinement, first cylindrical lens 203 reshapes the beam from 201. Therefore, the illumination beam on the sample 207 becomes a line. The scattered light from sample 207 is collected by the objective lens 206 and guided onto the 1D fiber array 210 through the quarter-wave plate 205, the polarized beam splitter 204, the first spherical lens 208, and the reflective mirror 209. The collected light is then delivered through the 1D fiber array 210 to the spectrum analysis unit, and the Brillouin spectrum is recorded by the camera 217 after the scatted light passes through the Rb gas filter 211, the second spherical lens 212, the second cylindrical lens 213, the VIPA etalon 214, and the third and the fourth cylindrical lens 215 and 216, respectively.

The apparatuses of FIGS. 1, 2, and 3 provide an improvement over the system described in U.S. Pat. Nos. 10,386,288; 10,598,594; and 10,732,092; the entire disclosures of which are hereby incorporated by reference. Therefore, many components of these patents can be used in the system of FIG. 1. For example, the subcomponents for collecting and measuring the Brillouin scattered light. Therefore, the entire disclosures of U.S. Pat. Nos. 10,386,288; 10,598,594; and 10,732,092 are hereby incorporated by reference in their entirety.

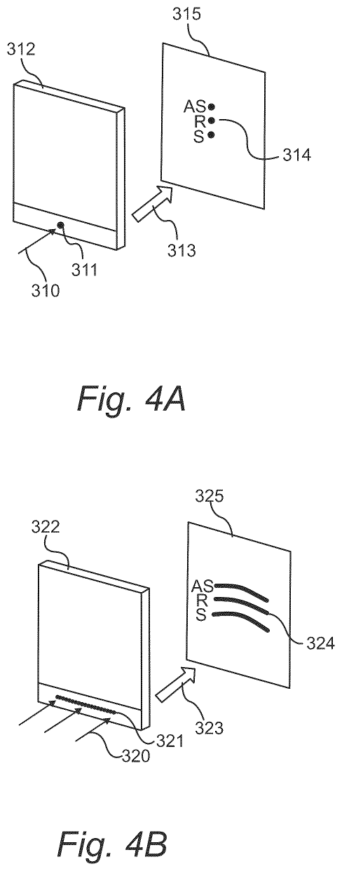

FIG. 4 explains the general advantage of line-scanning configuration compared with confocal configuration in Brillouin microscopy. In the confocal configuration, the scattered light 310 collected from the single point of the sample is focused into a beam spot 311 and projected onto the entrance window of the VIPA etalon 312. The outcoming light 313 from the VIPA etalon 312 is then projected into the Brillouin spectrum 314 and collected by camera 315. The Brillouin spectrum 314 consists of a triplet of dots (indicated by AS, R, and S), representing three components: Anti-Stokes Brillouin frequency, Rayleigh frequency, and Stokes Brillouin frequency. The Brillouin shift is then determined by the distance between Rayleigh frequency and either of Brillouin frequency. In line-scanning configuration, the scattered light 320 collected from the illumination line of the sample is focused into a beam line 321 and projected onto the entrance window of the VIPA etalon 322. The outcoming light 323 from the VIPA etalon 322 is then projected into the Brillouin spectrum 324 and collected by the camera 325. Similar to confocal configuration, the Brillouin spectrum 324 consists of three frequency components. However, since multiple points on the line are analyzed simultaneously, the line-scanning configuration can significantly reduce the measurement time for 2D/3D mapping.

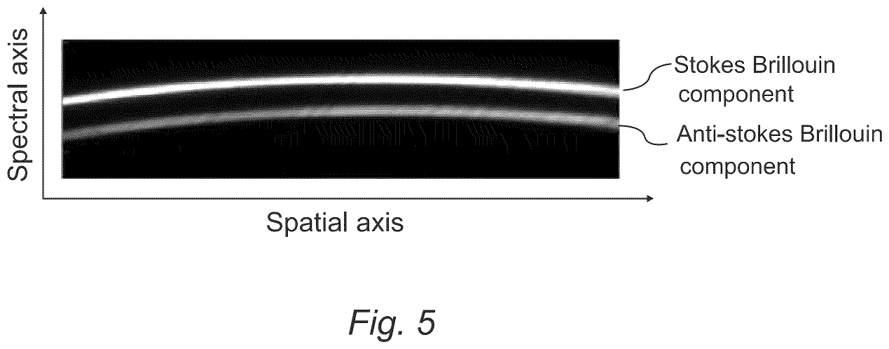

FIG. 5 shows a typical Brillouin spectrum acquired by the line-scanning Brillouin microscopy in experiment. Because the Rayleigh component was mostly filtered out by the Rb gas cell, the spectrum only shows the Stokes Brillouin frequency component and Anti-Stokes Brillouin frequency component, as indicated by the bright and dark lines, respectively. Horizontally, each pixel on the spectral line corresponds to one position of the sample. The Brillouin frequency shift at each pixel can be determined by measuring the vertical distance of two frequency components.

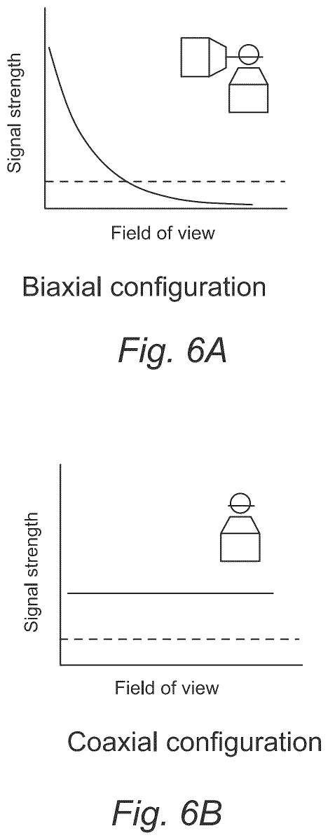

FIG. 6 shows the advantage of coaxial configuration compared with biaxial configuration for a non-transparent biological sample. In biological samples such as tissue, the absorption and scattering caused the light intensity to decay exponentially, as shown by the calculated curve in the biaxial configuration. Since the actual field-of-view is determined by the threshold of the light intensity (indicated by the dashed line), the designed field of view will not be fully used due to the decay of the light intensity along the illumination axis. In the coaxial configuration, however, the designed field-of-view will not be affected because the light intensities are always uniform along the illumination axis.

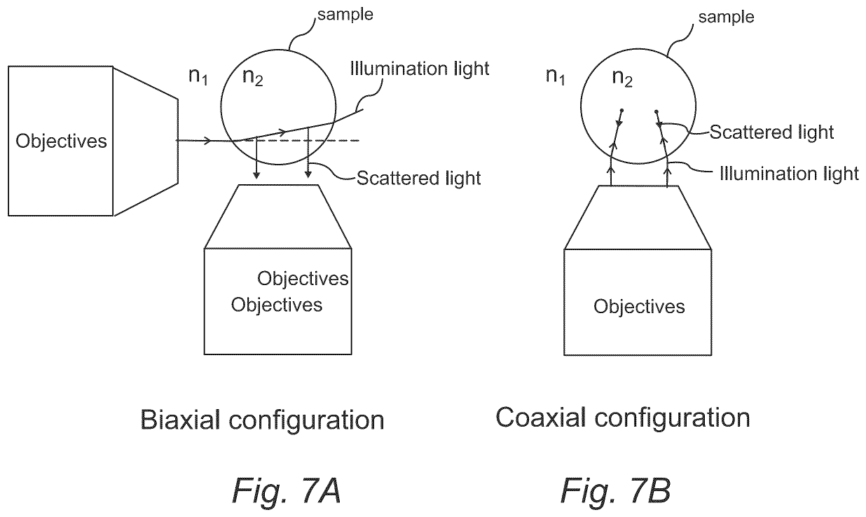

FIG. 7 demonstrates the advantage of coaxial configuration compared with biaxial configuration for inhomogeneous samples. The sphere represents the sample whose refractive index (n₂) is different from that of the ambient environment (n₁). In the biaxial configuration, because of the inhomogeneity, the illumination beam from the first objectives deviates from its original path as it goes into the sample. However, since the second objective only collects scattered light on the vertical direction, the scattering angle between the illumination and scattered light is not the preset value (i.e., 90°) but changes with the refractive index of the sample. This will introduce artifact to the measurement because the Brillouin shift is angle-dependent according to Equation (1). In practice, the distribution of the refractive index within the biological sample is more complicated, and thus the introduced artifact is more severe. In the coaxial configuration, since the scattered light follows the same path of the illumination light, the scattering angle (180°) is always conserved regardless of the change of the refractive index. Therefore, coaxial line-scanning Brillouin microscopy can remove the artifact caused by the inhomogeneous refractive index of the sample.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A line-scan Brillouin microscopy apparatus configured to operate in a coaxial configuration, the line-scan Brillouin microscopy apparatus comprising:
an illumination source that provides a P polarized illumination light beam for illuminating a sample;
a first optical assembly that provides the P polarized illumination light beam to the sample and collects initial Brillouin scattered light from the sample, the first optical assembly including an optical component that converts the initial Brillouin scattered light to S polarized Brillouin scattered light;
a second optical assembly to receive the S polarized Brillouin scattered light from the first optical assembly, the second optical assembly configured to induce a spectral dispersion; and
a detection unit to detect a spatio-spectral pattern of the initial Brillouin scattered light, wherein multiple points of the sample along P polarized illumination light beam are measured simultaneously.

2. The line-scan Brillouin microscopy apparatus of claim 1 further comprising a translatable sample holder that is configured to move the sample along a predetermined direction.

3. The line-scan Brillouin microscopy apparatus of claim 1, wherein the first optical assembly include a polarized beam splitter configured to reflect at least a portion of the P polarized illumination light beam towards the sample.

4. The line-scan Brillouin microscopy apparatus of claim 3, wherein the first optical assembly further includes a quarter-wave plate and an objective lens, the quarter-wave plate and the objective lens being configured to focus the P polarized illumination light beam onto the sample, the objective lens being also configured to collect the initial Brillouin scattered light and direct the initial Brillouin scattered light to the quarter-wave plate which converts the initial Brillouin scattered light to the S polarized Brillouin scattered light thereby allowing the polarized beam splitter to pass the S polarized Brillouin scattered light to the second optical assembly.

5. The line-scan Brillouin microscopy apparatus of claim 1, wherein the second optical assembly includes a virtually imaged phased array (VIPA), a Fabry-Perot etalon, or an optical grating.

6. The line-scan Brillouin microscopy apparatus of claim 5, wherein the second optical assembly further comprises optical elements to modify size, shape, and/or angular spread of the spatio-spectral pattern in an optical path from the sample to the detection unit.

7. The line-scan Brillouin microscopy apparatus of claim 1, wherein the detection unit includes an image sensor having a pixel array of photodetectors.

8. The line-scan Brillouin microscopy apparatus of claim 7, wherein the detection unit is a digital camera.

9. The line-scan Brillouin microscopy apparatus of claim 1, wherein the sample is a biological sample.

10. The line-scan Brillouin microscopy apparatus of claim 9, wherein the biological sample includes a biological organism and/or a tissue and/or biological cells including living cells.

11. The line-scan Brillouin microscopy apparatus of claim 1 further comprising a computing device configured to execute instructions for determining a detected spatio-spectral pattern.

12. The line-scan Brillouin microscopy apparatus of claim 11, wherein the computing device is further configured to execute instructions for:
calibrating the spatio-spectral pattern at each spatial point at the detection unit; and
calculating one or more Brillouin metrics at each measured sample point based on the detected spatio-spectral pattern.

13. The line-scan Brillouin microscopy apparatus of claim 12 wherein the one or more Brillouin metrics include a metric selected from the group consisting of Brillouin frequency shift, Brillouin spectrum line width, Brillouin gain or loss spectrum, and a combination thereof.

14. The line-scan Brillouin microscopy apparatus of claim 13, wherein the one or more Brillouin metrics determine a mechanical property of the sample.

15. The line-scan Brillouin microscopy apparatus of claim 14, wherein the mechanical property is selected from the group comprising elasticity, viscosity, stiffness, and combinations thereof.

16. A line-scan Brillouin microscopy apparatus configured to operate in a coaxial configuration, the line-scan Brillouin microscopy apparatus comprising:
an illumination source that provides a P polarized illumination light beam for illuminating a sample;
a first optical assembly that provides the P polarized illumination light beam to the sample and collects initial Brillouin scattered light from the sample, the first optical assembly including an optical component that converts the initial Brillouin scattered light to S polarized Brillouin scattered light, wherein the first optical assembly include a polarized beam splitter, a quarter-wave plate, and an objective lens, the polarized beam splitter configured to reflect at least a portion of the P polarized illumination light beam towards the sample, the quarter-wave plate and the objective lens being configured to focus the P polarized illumination light beam onto the sample, the objective lens being also configured to collect the initial Brillouin scattered light and direct the initial Brillouin scattered light to the quarter-wave plate which converts the initial Brillouin scattered light to the S polarized Brillouin scattered light;
a second optical assembly to receive the S polarized Brillouin scattered light from first optical assembly, the second optical assembly configured to induce a spectral dispersion; and
a detection unit to detect a spatio-spectral pattern of the initial Brillouin scattered light, wherein multiple points of the sample along the P polarized illumination light beam are measured simultaneously.

17. The line-scan Brillouin microscopy apparatus of claim 16 further comprising a translatable sample holder that is configured to move the sample along a predetermined direction.

18. The line-scan Brillouin microscopy apparatus of claim 16, wherein the second optical assembly includes a virtually imaged phased array (VIPA), a Fabry-Perot etalon, or an echelle grating.

19. The line-scan Brillouin microscopy apparatus of claim 18, wherein the second optical assembly further comprises optical elements to modify size, shape, and/or angular spread of the spatio-spectral pattern in an optical path from the sample to the detection unit.

20. The line-scan Brillouin microscopy apparatus of claim 16 further comprising a computing device configured to execute instructions for determining a detected spatio-spectral pattern.

21. A method for detecting one or more mechanical properties of a plurality of cells in the sample with the line-scan Brillouin microscopy apparatus of claim 1, the method comprising:
illuminating a sample with the P polarized illumination light beam; and
simultaneously measuring multiple points of the sample along the P polarized illumination light beam.

22. A line-scan Brillouin microscopy apparatus configured to operate in a coaxial configuration, the line-scan Brillouin microscopy apparatus comprising:
an illumination source that provides an unpolarized illumination light beam for illuminating a sample;
a first optical assembly that provides the unpolarized illumination light beam to the sample and collects Brillouin scattered light;
a second optical assembly to receive the Brillouin scattered light from the first optical assembly, the second optical assembly configured to induce a spectral dispersion; and
a detection unit to detect a spatio-spectral pattern of the Brillouin scattered light, wherein multiple points of the sample along the unpolarized illumination light beam are measured simultaneously.

23. The line-scan Brillouin microscopy apparatus of claim 22 further comprising a translatable sample holder that is configured to move the sample along a predetermined direction.

24. The line-scan Brillouin microscopy apparatus of claim 22, wherein the first optical assembly include a beam splitter configured to reflect at least a portion of the unpolarized illumination light beam towards the sample.

25. The line-scan Brillouin microscopy apparatus of claim 24, wherein the first optical assembly further includes an objective lens configured to focus the unpolarized illumination light beam onto the sample, the objective lens also being configured to collect and direct the Brillouin scattered light to the second optical assembly.

26. The line-scan Brillouin microscopy apparatus of claim 22, wherein the second optical assembly includes a virtually imaged phased array (VIPA), a Fabry-Perot etalon, or an optical grating.

27. The line-scan Brillouin microscopy apparatus of claim 26, wherein the second optical assembly further comprises optical elements to modify size, shape, and/or angular spread of the spatio-spectral pattern in an optical path from the sample to the detection unit.

28. The line-scan Brillouin microscopy apparatus of claim 22, wherein the detection unit includes an image sensor having a pixel array of photodetectors.

29. The line-scan Brillouin microscopy apparatus of claim 28, wherein the detection unit is a digital camera.

30. The line-scan Brillouin microscopy apparatus of claim 22, wherein the sample is a biological sample.

31. The line-scan Brillouin microscopy apparatus of claim 30, wherein the biological sample includes a biological organism and/or a tissue and/or biological cells including living cells.

32. The line-scan Brillouin microscopy apparatus of claim 22 further comprising a computing device configured to execute instructions for determining a detected spatio-spectral pattern.

33. The line-scan Brillouin microscopy apparatus of claim 32, wherein the computing device is further configured to execute instructions for:
calibrating the spatio-spectral pattern at each spatial point at the detection unit; and
calculating one or more Brillouin metrics at each measured sample point based on the detected spatio-spectral pattern.

34. The line-scan Brillouin microscopy apparatus of claim 33 wherein the one or more Brillouin metrics include a metric selected from the group consisting of Brillouin frequency shift, Brillouin spectrum line width, Brillouin gain or loss spectrum, and a combination thereof.

35. The line-scan Brillouin microscopy apparatus of claim 34, wherein the one or more Brillouin metrics determine a mechanical property of the sample.

36. The line-scan Brillouin microscopy apparatus of claim 35, wherein the mechanical property is selected from the group comprising elasticity, viscosity, stiffness, and combinations thereof.
